(19) United States
(12) Patent Application Publication
(10) Pub. No.: US 2026/0184163 A1
(43) Pub. Date: Jul. 2, 2026

(54) ACTIVE AND PASSIVE CLUTCH ASSEMBLY AND HALF SHAFT DISCONNECT ARRANGEMENT

(71) Applicant: Means Industries, Inc., Saginaw, MI (US)

(72) Inventors: Jipeng Fan, Fairfax, VA (US); Douglas Brubaker, Midland, MI (US); Spencer Kane, Chesaning, MI (US)

(21) Appl. No.: 18/855,463

(22) PCT Filed: May 17, 2024
(86) PCT No.: PCT/US2024/029851

§ 371 Date: Oct. 9, 2024

Related U.S. Application Data
(60) Provisional application No. 63/471,583, filed on Jun. 7, 2023.

(51) Int. Cl. B60K 17/35; B60K 6/383

(52) U.S. Cl. CPC B60K 17/3515; B60K 6/383

(57) ABSTRACT

A clutch assembly includes a first coupling including a locking face including locking formations, and a second coupling including a front face facing the locking face of the first coupling and including passive strut pockets, active strut pockets circumferentially interspersed amongst the plurality of passive strut pockets, and actuator passages open to the plurality of active strut pockets. Passive struts are carried in the passive strut pockets of the second coupling, and active struts, different from the passive struts, are carried in the active strut pockets of the second coupling. Also disclosed are a related axle configuration, and a related method of operating a motor vehicle drivetrain.

### CROSS-REFERENCE TO RELATED APPLICATION

This application is a National State of International Application No. PCT/2024/029851, filed on May 17, 2024, and claims the benefit of U.S. Provisional Application No. 63/471,583 filed Jun. 7, 2023, the contents of which are incorporated herein by reference in their entireties.

### TECHNICAL FIELD

This disclosure relates generally to drivetrains and, more particularly, to clutch assemblies and axle half shaft arrangements for motor vehicle drivetrains.

### BACKGROUND

An axle of a motor vehicle may include half shafts that each couple to a vehicle wheel. In just one of many possible examples, an electric motor may be coupled to an input of a geartrain to drive the geartrain, and a first half shaft may be coupled a first output of the geartrain and a second half shaft may be coupled to a second output of the geartrain. In some implementations it is desirable to decouple one or both of the half shafts from its respective wheel via one or more disconnect devices. Unfortunately, presently available half shaft disconnect devices are unnecessarily complex, costly, or of cumbersome size.

### BRIEF SUMMARY

An illustrative embodiment of an axle configuration includes a geartrain having an input, a first output coupled to a first axle shaft, and a second output, and a clutch having an input coupled to the second output of the geartrain, and an output, wherein the clutch includes a passive overrunning clutch.

An illustrative embodiment of a clutch assembly includes a first coupling including a locking face including a plurality of locking formations, and a second coupling including a front face facing the locking face of the first coupling and including a plurality of passive strut pockets, a plurality of active strut pockets circumferentially interspersed amongst the plurality of passive strut pockets, and a plurality of actuator passages open to the plurality of active strut pockets. The clutch assembly also includes a plurality of passive struts carried in the passive strut pockets of the second coupling, and a plurality of active struts, different from the passive struts, and carried in the active strut pockets of the second coupling.

An illustrative embodiment of a method of operating a motor vehicle drivetrain, includes driving a geartrain in a vehicle forward two-wheel drive mode, wherein a clutch assembly coupled between the geartrain and a vehicle wheel is in an overrunning passive one way clutch state with a dynamically controllable clutch deactivated, and driving the geartrain in a vehicle forward four-wheel drive mode, wherein the clutch assembly is in an engaged passive one way clutch state with the dynamically controllable clutch deactivated. The method also includes driving the geartrain in a vehicle reverse four-wheel drive mode, wherein the clutch assembly is in an engaged passive one way clutch state with the dynamically controllable clutch activated, and driving the geartrain in a regenerative vehicle forward four-wheel drive mode, wherein the clutch assembly is in an engaged passive one way clutch state with the dynamically controllable clutch activated.

### BRIEF DESCRIPTION OF THE DRAWINGS

FIG. 1A is a schematic view according to an illustrative embodiment of an axle configuration including a prime mover, a geartrain including compound planetary gearsets, half shafts, wheels, and a half shaft disconnect device, which may be a single plane dynamically controllable clutch and passive one way clutch;

FIG. 1B is a schematic view according to another illustrative embodiment of an axle configuration including many of the portions shown in FIG. 1A, except wherein the geartrain includes epicyclic gearsets including a differential;

FIG. 2 is a side view the clutch of FIG. 1A and inner and outer half shaft portions coupled thereto;

FIG. 3 is an exploded view of an illustrative embodiment of the clutch of FIG. 1A;

FIG. 4 is an enlarged, partial, isometric view of a portion of the clutch of FIG. 1A, illustrating passive forward clutch struts and dynamically controllable reverse clutch struts;

FIG. 5 is an enlarged, partial, isometric view of a portion of the clutch of FIG. 1A, illustrated with strut retainer plates and rivets removed;

FIG. 6 is an end view of the clutch of FIG. 1A;

FIG. 7 is a sectional view of the clutch of FIG. 1A, taken along line 7-7 of FIG. 6 and illustrating the clutch in a deactivated state;

FIG. 8 is a sectional view of the clutch of FIG. 1A, taken along line 7-7 of FIG. 6 and illustrating the clutch in an activated state;

FIG. 9 is a sectional view of the clutch of FIG. 1A, taken along line 9-9 of FIG. 6 and illustrating the clutch in the deactivated state according to a first mode, wherein the reverse struts are disengaged and the forward struts overrun;

FIG. 10A is a schematic view of the axle configuration of FIG. 1A, illustrating the clutch in the first mode;

FIG. 10B is a schematic view of the axle configuration of FIG. 1B, illustrating the clutch in the first mode;

FIG. 11 is a sectional view of the clutch of FIG. 1A, taken along line 9-9 of FIG. 6 and illustrating the clutch in the deactivated state according to a second mode, wherein the reverse struts are disengaged and the forward struts are in a position to engage;

FIG. 12A is a schematic view of the axle configuration of FIG. 1A, illustrating the clutch in the second mode;

FIG. 12B is a schematic view of the axle configuration of FIG. 1B, illustrating the clutch in the second mode;

FIG. 13 is a sectional view of the clutch of FIG. 1A, taken along line 9-9 of FIG. 6 and illustrating the clutch in the activated state according to a third mode, wherein the reverse struts are engaged and the forward struts are raised or are in a position to engage but do not transfer load;

FIG. 14A is a schematic view of the axle configuration of FIG. 1A, illustrating the clutch in the third mode;

FIG. 14B is a schematic view of the axle configuration of FIG. 1B, illustrating the clutch in the third mode;

FIG. 15 is a sectional view of the clutch of FIG. 1A, taken along line 9-9 of FIG. 6 and illustrating the clutch in the activated state according to a fourth mode, wherein the reverse struts are engaged and the forward struts are raised or engaged but do not transfer load;

FIG. 16A is a schematic view of the axle configuration of FIG. 1A, illustrating the clutch in the fourth mode;

FIG. 16B is a schematic view of the axle configuration of FIG. 1B, illustrating the clutch in the fourth mode; and

FIG. 17 is a schematic view of the axle configuration of FIG. 1B, illustrating the clutch in a fifth mode.

### DETAILED DESCRIPTION

In general, an apparatus and method will be described using one or more examples of illustrative embodiments of a disconnect device that connects and disconnects a motor vehicle drivetrain element with respect to a vehicle wheel. The example embodiment(s) will be described with reference to its use in an axle half shaft configuration. However, it will be appreciated as the description proceeds that the invention is useful in many different applications and may be implemented in many other embodiments. For example, the apparatus can be used in a drivetrain differential, or a powertrain transmission, or any other suitable powertrain or drivetrain for motor vehicles including automotive passenger cars, commercial trucks, or any other suitable wheeled vehicles, or even in powertrains or drivetrains for marine vessels, construction equipment, windmills, or any application where clutches are desirable.

As used herein, the terminology “for example,” “e.g.,” for instance,” “like,” “such as,” “comprising,” “having,” “including,” and the like, when used with a listing of one or more elements, is to be construed as open-ended, meaning that the listing does not exclude additional elements. As used herein, permissive terms like “may” and “can” are expedients merely to indicate optionality, for instance, of a disclosed embodiment, element, feature, or the like, and should not be construed as rendering indefinite any disclosure herein. Moreover, directional words such as front, rear, top, bottom, upper, lower, radial, circumferential, axial, lateral, longitudinal, vertical, horizontal, transverse, and/or the like are employed by way of example and not necessarily limitation.

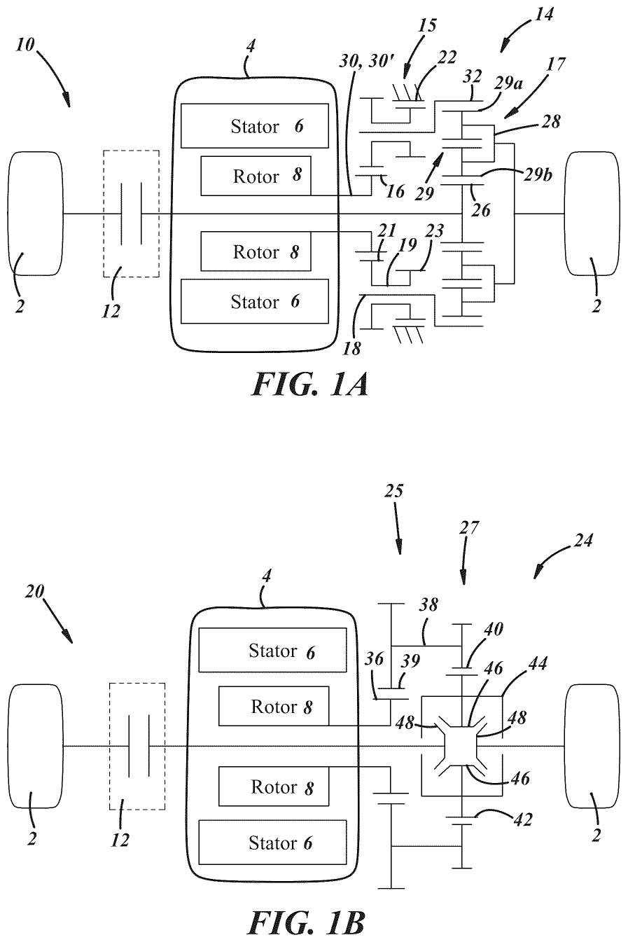

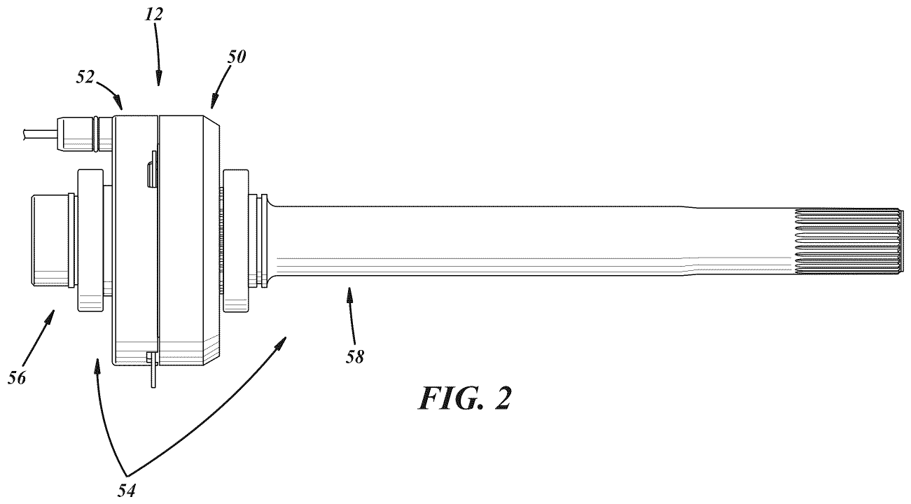

Referring specifically to the drawings, FIG. 1A shows an illustrative embodiment of a portion of a motor vehicle drivetrain including an axle configuration, for example for a front axle 10, having a drivetrain-to-wheel disconnect arrangement. A prime mover 4 is coupled to a geartrain 14, wheels 2 are coupled to the geartrain 14, and a disconnect device 12 is coupled between the geartrain 14 and one of the wheels 2. As will be described in greater detail below, an embodiment of the presently disclosed disconnect device includes a novel configuration that is particularly compact relative to its torque carrying capacity relative to prior devices used for the same purpose.

The prime mover 4 may be an electric motor, as illustrated, or an engine, or any other prime mover suitable for driving a drivetrain of a motor vehicle. The illustrative electric motor may include a stator 6 and a rotor 8 rotatable with respect to the stator 6 about a rotational axis, and may include an output shaft 30 fixed with respect to the rotor 8 for coupling to the geartrain 14. Or the geartrain 14 may include an input member 30′ coupled directly to the rotor 8. In any event, the rotor 8 of the electric motor may rotate in a clockwise direction about the rotational axis, a counterclockwise direction, or both. In an example application, a motor vehicle may include dual powered axles and the presently disclosed apparatus may be implemented on a secondary axle of an electric vehicle, for example, a front axle.

The geartrain 14 may include first and second compound planetary gearsets 15, 17, as illustrated, or any other gearset(s) suitable for use in a drivetrain. The illustrative first planetary gearset 15 includes a first sun gear 16, a first pinion gear carrier 18, a first set of pinion gears 19 carried by the first pinion gear carrier 18, and a first ring gear 22. The first set of pinion gears 19 may include stepped pinion gears having an input side 21 in mesh with the first sun gear 16, which serves as an input element, and also having an output side 23 with less gear teeth than the input side 21 and in mesh with the first ring gear 22, which is grounded. The illustrative second planetary gearset 17 includes a second sun gear 26, a second pinion gear carrier 28, a second set of pinion gears 29 carried by the second pinion gear carrier 28, and a second ring gear 32. The second set of pinion gears 29 may include an outer input subset 29a of pinion gears and an inner output subset 29b of pinion gears in mesh with the outer input subset 29a and with the second sun gear 26, which serves as an output element. In the illustrative arrangement, the first sun gear 16 is coupled to the rotor 8 of the electric motor via a shaft or the like, the first ring gear 22 is grounded, the first pinion gear carrier 18 is fixed with respect to the second ring gear 32 of the second planetary gear set 17, the second pinion gear carrier 28 is a first output of the geartrain 14 fixed with respect to one of the wheels 2, and the second sun gear 26 is a second output of the geartrain 14 coupled to another one of the wheels 2 via the disconnect device 12.

The disconnect device 12 may be located between the electric motor 4 and one of the wheels 2 to which the disconnect device 12 is coupled, for example, indirectly via the partial half shaft and other componentry not illustrated, and the geartrain 14 may be located between the electric motor 4 and the other wheel 2. The disconnect device 12 may include a passive overrunning clutch, for example, a passive one way clutch that is passively operated for a forward vehicle two wheel mode. In embodiments where axial length is not of particular concern, the disconnect device 12 may include a dual plane dynamically controllable clutch (DCC) and passive one way clutch (OWC). Dynamically controllable clutches are known, for example, as set forth in U.S. Pat. No. 11,286,996 assigned to the assignee hereof and, likewise, passive one way clutch mechanisms and active one way clutch mechanisms are known, for example, as set forth in US Patent Application Publication 2023/0160461 assigned to the assignee hereof, and as set forth in US Patent Application Publication US 2023/0332653A1 assigned to the assignee hereof and filed on Apr. 10, 2023. The contents of the above applications are incorporated herein by reference in their entireties. But passive one way clutch functionality on a half shaft is not believed to be known.

FIG. 1B shows an illustrative embodiment of a portion of a motor vehicle drivetrain including another axle configuration, for example for a rear axle 20, having a drivetrain-to-wheel disconnect arrangement. The configuration shown in FIG. 1B is nearly identical to the configuration of FIG. 1A with the exception of type of geartrain. A geartrain 24 of FIG. 1B includes first and second epicyclic gearsets 25, 27, or any other gearset(s) suitable for multiplying torque in a drivetrain. The illustrative first epicyclic gearset 25 includes a first sun gear 36, a shared or common pinion gear carrier 38, and a first set of pinion gears 39 carried by the common pinion gear carrier 38. Similarly, the illustrative second epicyclic gearset 27 includes the common pinion gear carrier 38, a second set of pinion gears 40 carried by the common pinion gear carrier 38, a second sun gear 42 coupled to an exterior of a differential case 44, and differential bevel input and output gears 46, 48 carried in an interior of the differential case 44. In the illustrative arrangement, the first sun gear 36 is coupled to the rotor 8 of the electric motor via a shaft or the like, the common pinion gear carrier 38 carries both the first and second set of pinion gears 39, 40, the second sun gear 42 is fixed to the differential case 44, one of the differential bevel output gears 48 is a first output of the geartrain 24 fixed with respect to one of the wheels 2, and another one of the differential bevel output gears 48 is a second output of the geartrain 24 coupled to another one of the wheels 2 via the disconnect device 12.

With reference now to FIG. 2, the disconnect device 12 may include a single plane dynamically controllable clutch with one way clutch functionality in a forward direction. The presently disclosed disconnect device enables passive engagement and disengagement of a half shaft to provide quicker and easier control to engage and disengage a secondary axle of dual motorized axles of an electric vehicle. The disconnect device 12 includes a coupling portion 50 and a control portion 52 coupled to the coupling portion 50. A half shaft 54 includes a first/input/inboard half shaft portion 56 coupled at an input side of the disconnect device 12, and a second/output/outboard half shaft portion 58 coupled at an output side of the disconnect device 12.

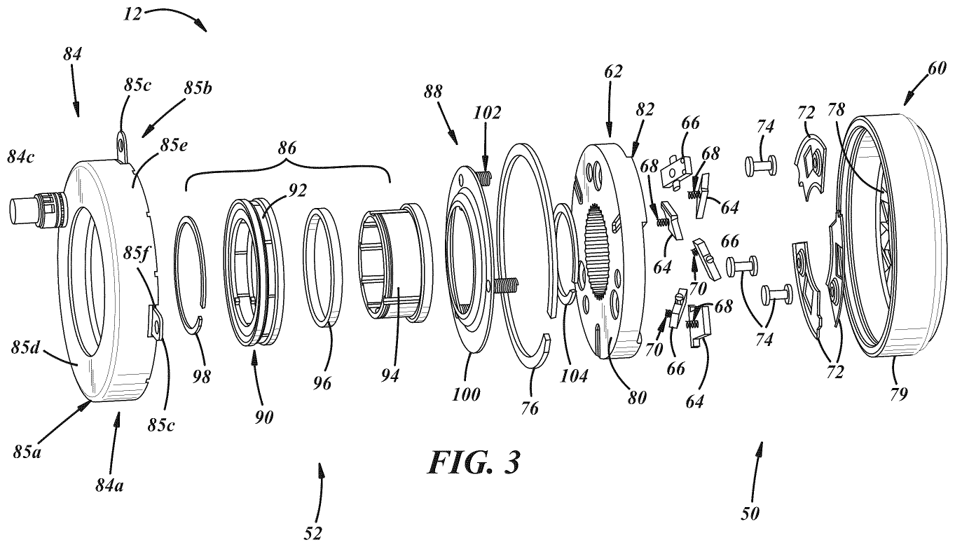

With reference now to FIG. 3, the coupling portion 50 includes a first coupling member or notch plate 60, a second coupling member or pocket plate 62, and a plurality of locking members or struts 64, 66 operatively between the notch plate 60 and the pocket plate 62. The coupling portion 50 also may include strut springs 68, 70 to bias the struts 64, 66, one or more apertured retainer plates 72, retainer plate rivets 74 to fix the retainer plate(s) 72 to the pocket plate 62, and a retainer ring 76 that couples to the notch plate 60 to retain the pocket plate 62 to the notch plate 60.

The notch plate 60 may be a bowl-shaped component having a radially extending base wall 78 with a splined inner diameter and a notch face with notches for coupling to the struts 64, 66, and an axially extending wall 79 extending axially away from a radially outer periphery of the base wall 78 and having an internal retainer ring groove therein.

The pocket plate 62 may be a generally plate-shaped component having a radially extending base wall 80 with a splined inner diameter, actuator passages extending therethrough, strut pockets in a front face that faces the notch plate 60, and shoulders 82 for circumferentially locating the retainer plates 72. Notably, all strut pockets are in the front face that faces the notch plate 60.

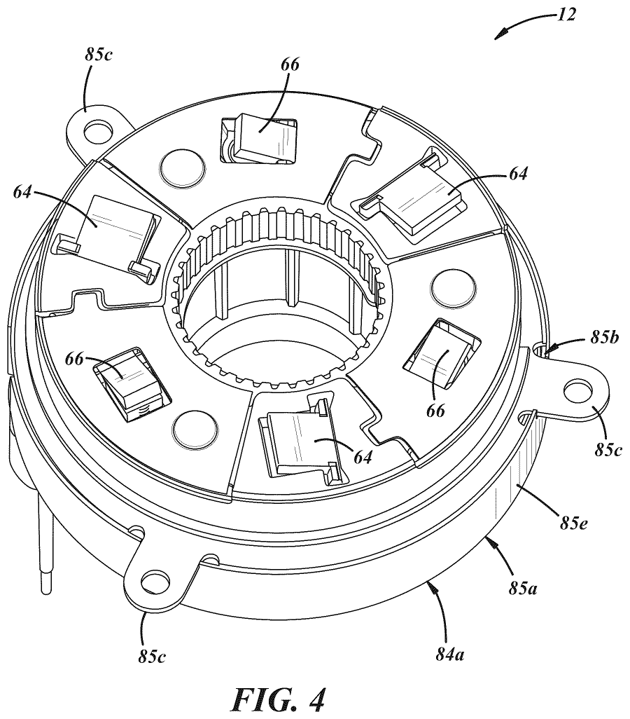

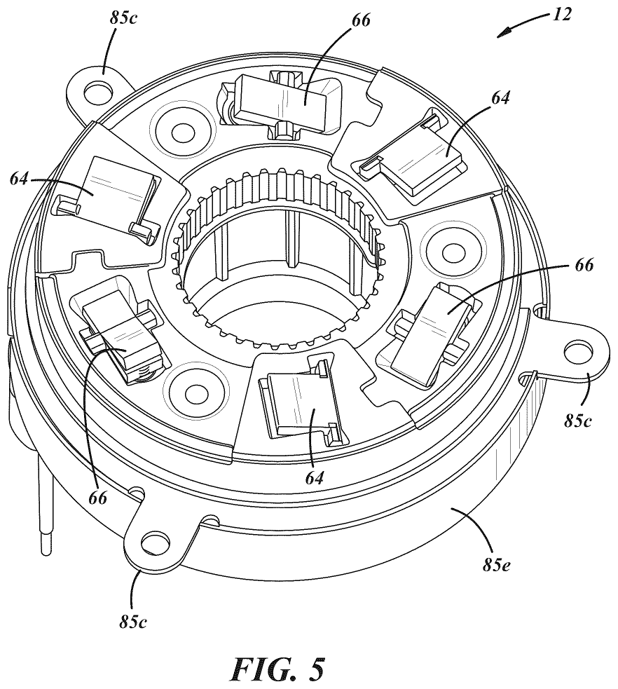

With additional reference to FIGS. 4 and 5, the locking members may include a set of forward struts 64 and strut springs 68 and a set of reverse struts 66 and strut springs 70. The forward struts 64 are passive one way clutch struts, whereas the reverse struts 66 are dynamically controllable clutch struts. Accordingly, the forward struts 64 may be carried in blind pockets on the front face of the pocket plate 62, whereas the reverse struts 66 are carried in pockets open to the actuator passages so as to be actuated by the actuator elements. The forward struts 64 are circumferentially interspersed amongst the reverse struts 66. Accordingly, in a vehicle forward direction the clutch passively engages. Notably, all of the forward and reverse struts 64, 66 are on the front side in the front face of the pocket plate 62 such that all struts 64, 66 are in a common operational plane or in a “single plane” as opposed to being axially spaced apart in dual or multiple planes as provided in other clutch designs.

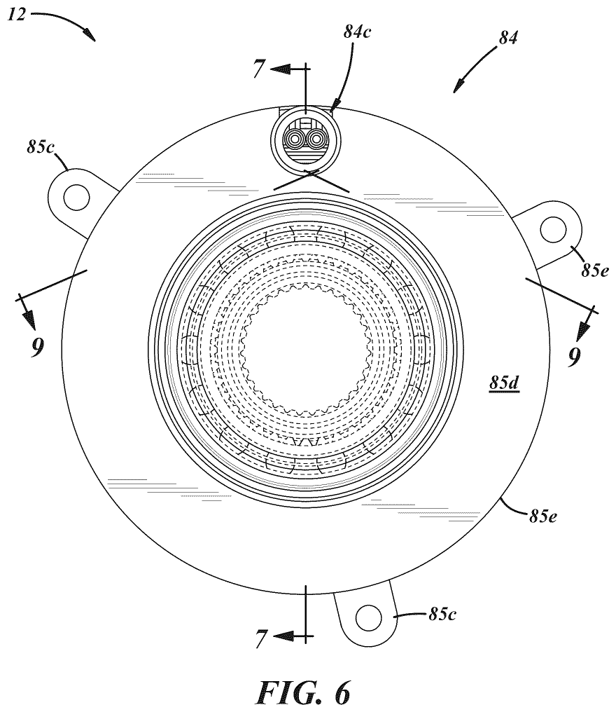

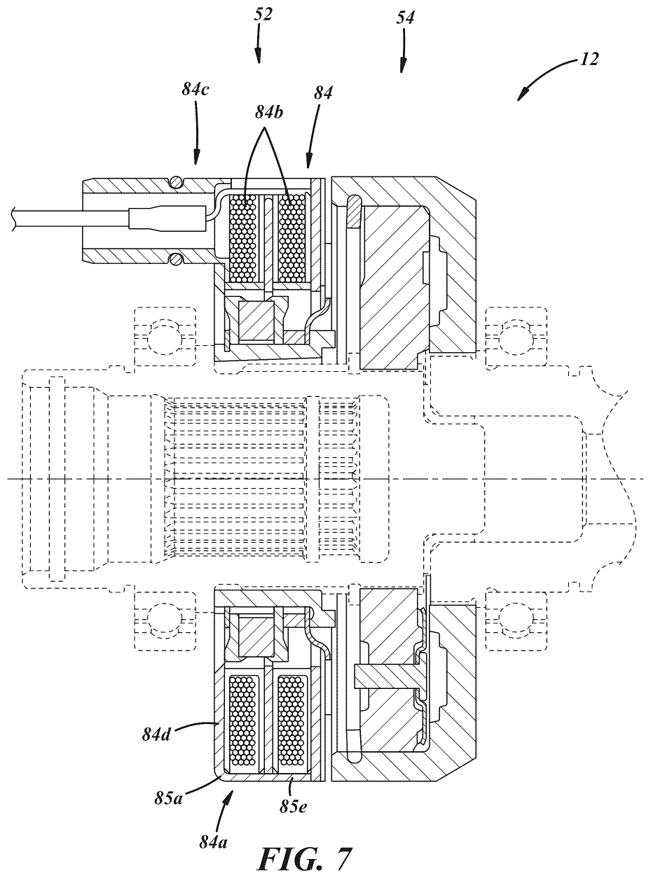

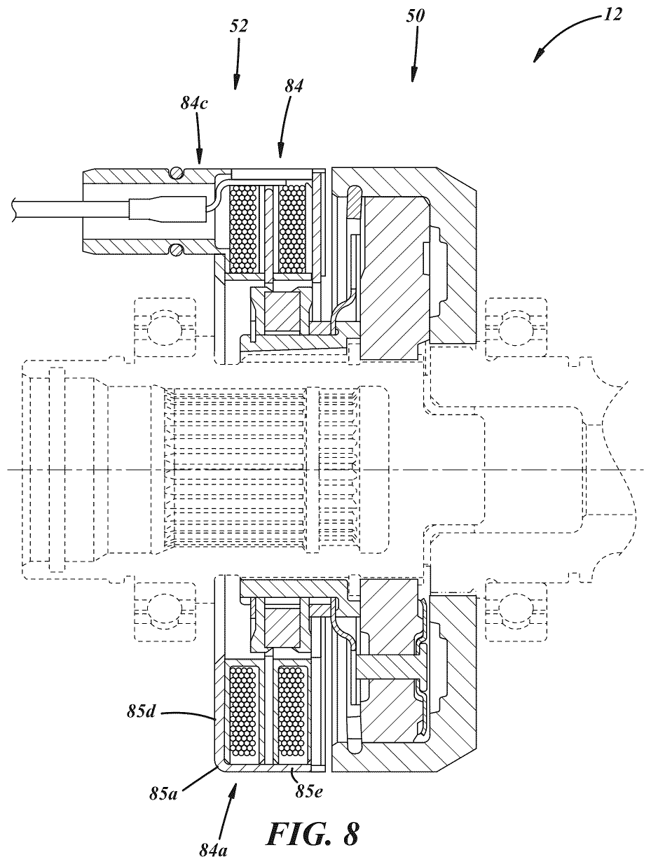

With reference again to FIG. 3, the control portion 52 includes a stator assembly 84, a translator 86, and an actuator assembly 88. The stator assembly 84 may include a housing 84a, coils 84b (FIG. 7), and wire connector 84c coupled to the housing 84a for carrying wires to the coils 84b. The translator 86 may include a ferrous carrier ring 90 and a plurality of magnets 92 that may be arcuate, a translator hub 94, a translator spacer 96 between the hub 94 and the ferrous carrier ring 90, and a translator retainer ring 98 to retain the ferrous carrier ring 90 and spacer 96 to the translator hub 94. The actuator assembly 88 may include a plate 100 carried by the translator hub 94 and a plurality of circumferentially spaced actuator elements 102, for example, springs, carried by the plate 100. A half shaft snap ring 104 may be used to axially retain the clutch to a half shaft (not shown). Notably, the housing 84a may include a pan member 85a and a cover member 85b. The cover member 85b has an outer diameter and bolt tabs 85c extend beyond the outer diameter. The pan member 85a includes a base wall 85d with a central aperture and an axially extending wall 85e extending axially away from the base wall 85d and terminating in a recessed inner shoulder against which the outer diameter of the cover member locates and having reliefs 85f in an end surface thereof to accommodate passage of the bolt tabs 85c. With additional reference to FIG. 6, the control portion 52 also includes any suitable electrical wire connector 84c coupled to the housing 84a, for example, the base wall 85d of the housing 84a. With additional reference to FIGS. 7 and 8, the control portion 52 may constitute a bi-stable actuator to actuate the dynamically controllable clutch struts.

The presently disclosed and illustrated apparatus is compact. For example, the illustrated clutch has an axial length of 51.7 mm and a major outer diameter of 120 mm and a minor inner diameter of 44 mm. Accordingly, the illustrated clutch has an axial length to major outer diameter ratio of 0.43. The clutch is capable of carrying an ultimate torque of 6300 Nm and a high cycle torque of 2100 Nm for 300,000 cycles, and rotating at a highest overrun speed of 3000 RPM (pocket plate at 1500 RPM, and notch plate at 1500 RPM) and with a maximum speed after engagement of 2250 RPM, and has a response time (from sending signal to engagement)<30 ms (ultimate low temperature use cases are exceptional). For these performance specifications, the presently disclosed apparatus may have an axial length to diameter ratio of less than 0.5, and, for example, between 0.4 and 0.5, including all ranges, sub-ranges, endpoints, and values in that range.

A method of operating a motor vehicle drivetrain may include several steps, as follows.

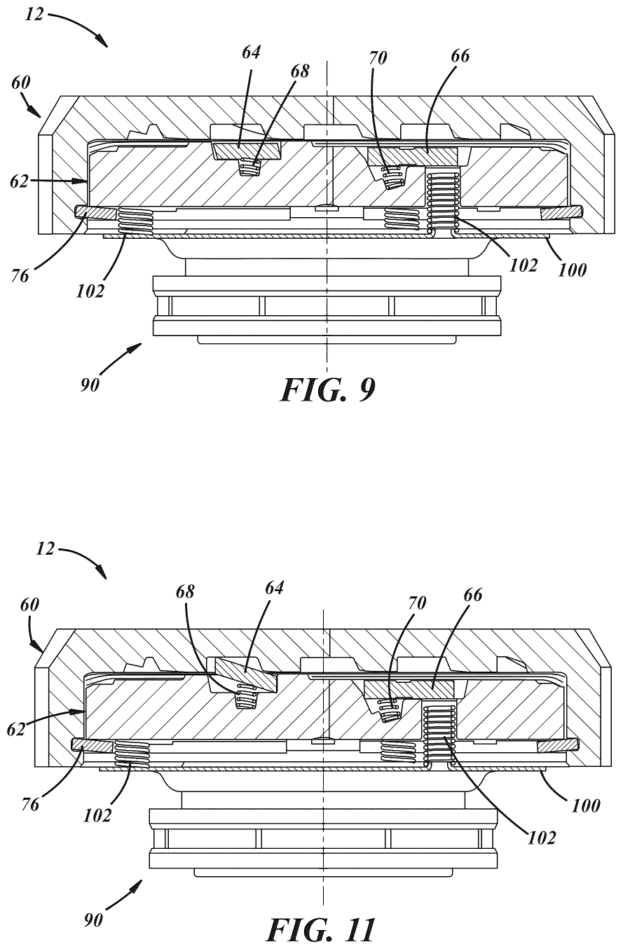

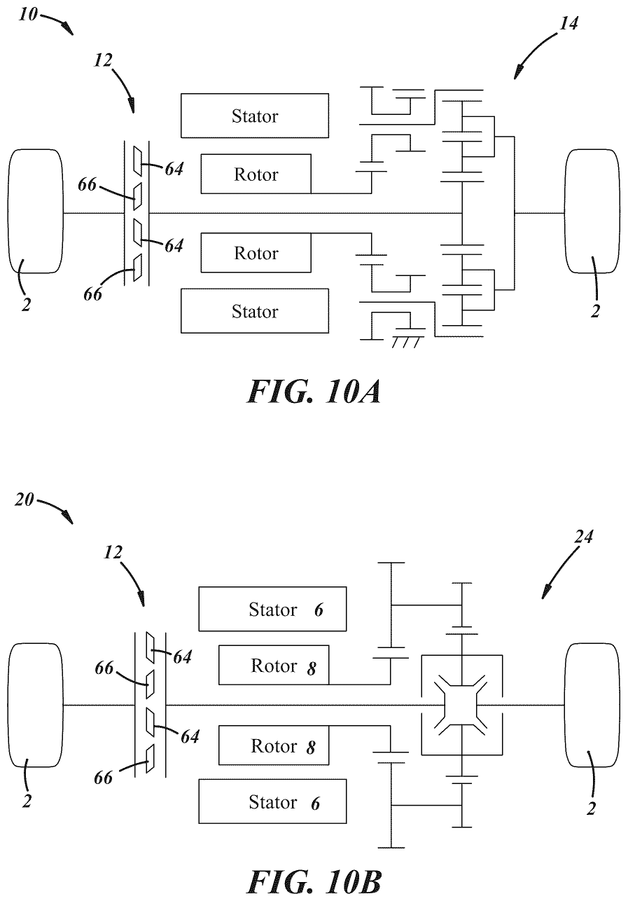

First, with reference to FIGS. 9 and 10A-B, the method may include driving a geartrain in a vehicle forward two-wheel drive mode, wherein a clutch assembly coupled between the geartrain and a vehicle wheel is in an overrunning passive one way clutch state with a dynamically controllable clutch deactivated. This may be referred to as a first mode, wherein the reverse or DCC struts 66 are disengaged and the forward or OWC struts 64 overrun. Any suitable prime mover may be used to drive the geartrain in any suitable manner.

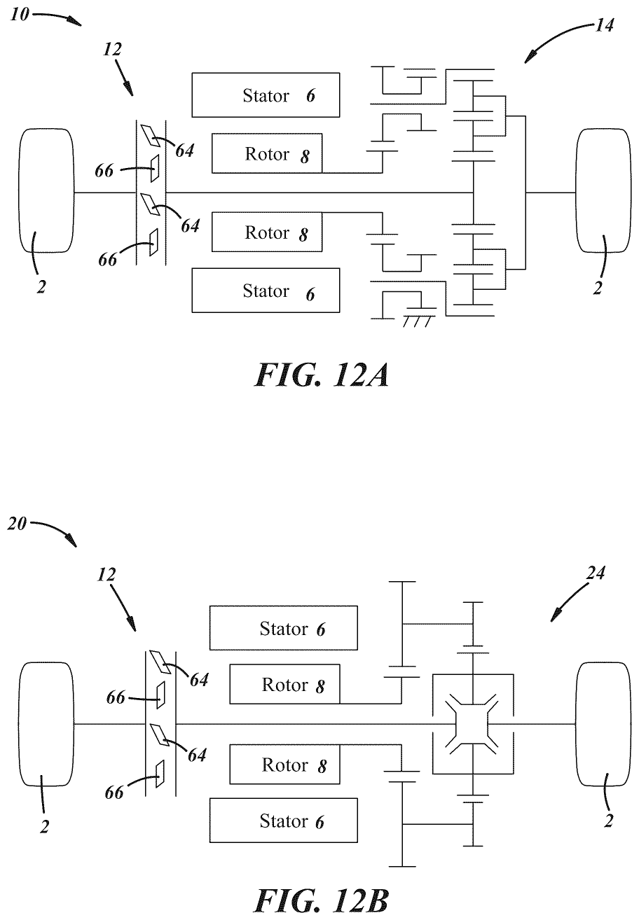

Second, with reference to FIGS. 11 and 12A-B, the method may include driving the geartrain in a vehicle forward four-wheel drive mode, wherein the clutch assembly is in an engaged passive one way clutch state with the dynamically controllable clutch deactivated. This may be referred to as a second mode, wherein the reverse or DCC struts 66 are disengaged and the forward or OWC struts 64 are engaged. Any suitable prime mover may be used to drive the geartrain in any suitable manner.

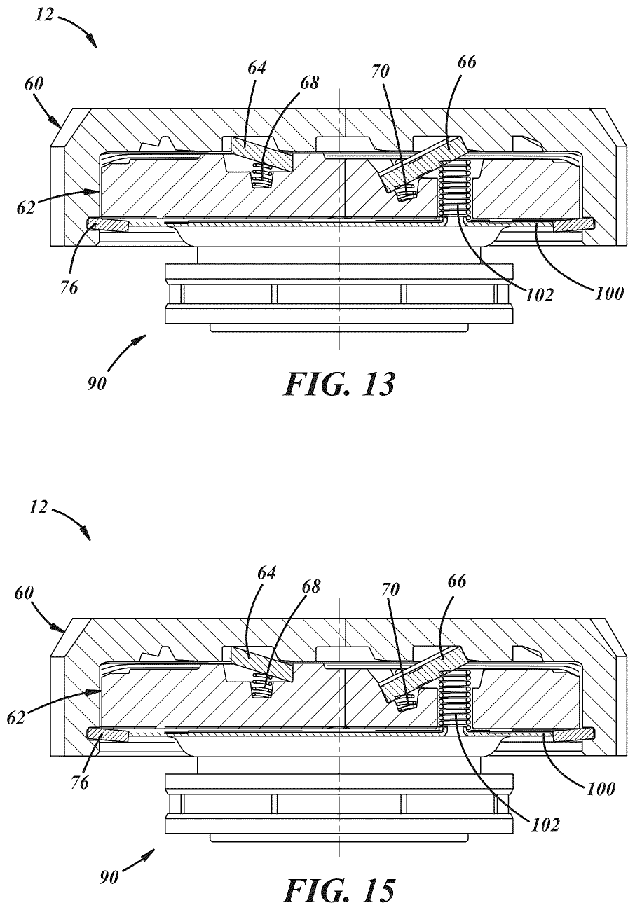

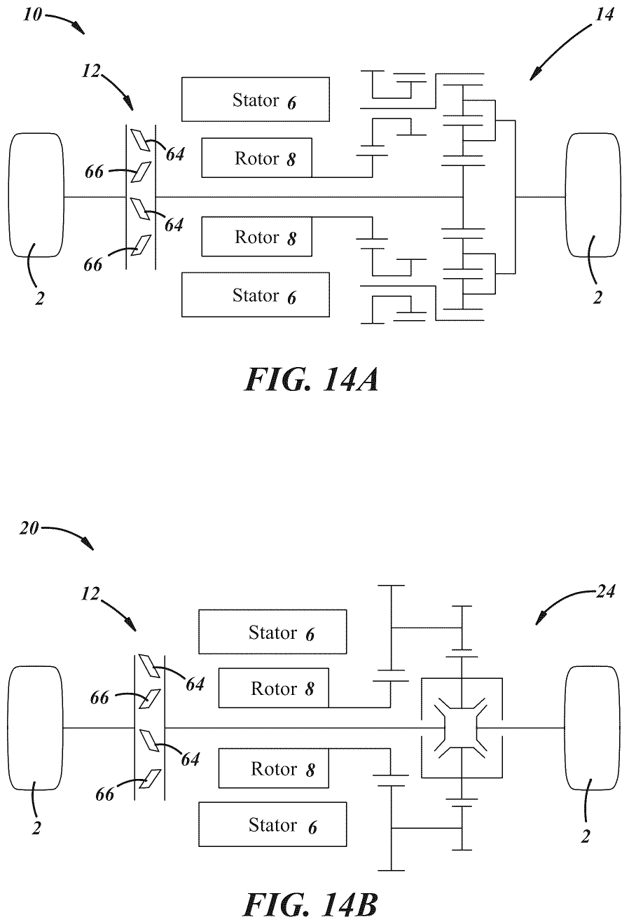

Third, with reference to FIGS. 13 and 14A-B, the method may include driving the geartrain in a vehicle reverse four-wheel drive mode, wherein the clutch assembly is in an engaged passive one way clutch state with the dynamically controllable clutch activated. This may be referred to as a third mode, wherein the reverse or DCC struts 66 are engaged and the forward or OWC struts 64 are raised or engaged but do not transfer load. Any suitable prime mover may be used to drive the geartrain in any suitable manner.

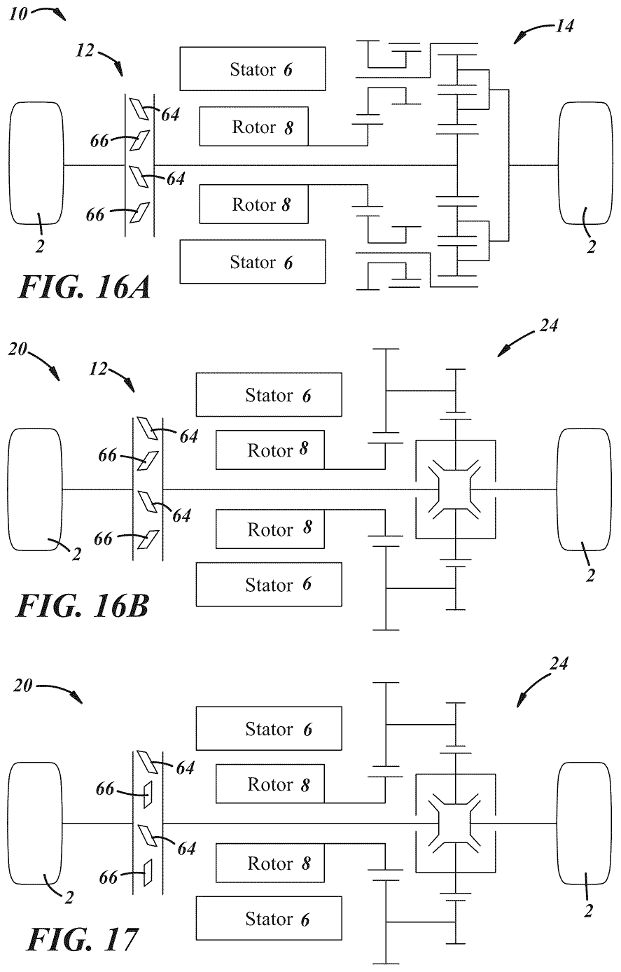

Fourth, with reference to FIGS. 15 and 16A-B, the method may include driving the geartrain in a regenerative vehicle forward four-wheel drive mode, wherein the clutch assembly is in an engaged passive one way clutch state with the dynamically controllable clutch activated. This may be referred to as a fourth mode, wherein the reverse or DCC struts 66 are engaged and the forward or OWC struts 64 are raised or engaged but do not transfer load. Forward motion of the vehicle and resultant rotation of the vehicle's wheels may be used to drive the geartrain in any suitable manner in a regenerative mode.

Fifth, with reference to FIG. 17, the method also may include driving the geartrain in a reverse two-wheel drive mode, wherein the clutch assembly is an engaged passive one way clutch state with the dynamically controllable clutch deactivated. This may be referred to as a fifth mode, wherein the reverse or DCC struts 66 are disengaged and the forward or OWC struts 64 are engaged. In this mode, another portion of the vehicle, for example, another axle (not separately shown), may be equipped with an electrical machine that undergoes a regenerative vehicle reverse two-wheel drive mode.

Contrary to conventional wisdom in the art of clutches and disconnect devices, the presently disclosed apparatus does not involve a typical design that cannot be packaged with an axle half shaft configuration. Instead, the presently disclosed apparatus provides a compact, simple, and inexpensive alternative to prior axle half shaft disconnect arrangements. Moreover, the presently disclosed apparatus does not require active control to provide half shaft engagement in the vehicle forward direction and, instead, relies on one way clutch functionality to provide half shaft engagement in the vehicle forward direction. Accordingly, one way clutch functionality may save time and effort for speed tuning before engagement of a half shaft, and is operational with regenerative and four wheel reverse mode functionality.

Finally, the subject matter of this application is presently disclosed in conjunction with several explicit illustrative embodiments and modifications to those embodiments, using various terms. All terms used herein are intended to be merely descriptive, rather than necessarily limiting, and are to be interpreted and construed in accordance with their ordinary and customary meaning in the art, unless used in a context that requires a different interpretation. And for the sake of expedience, each explicit illustrative embodiment and modification is hereby incorporated by reference into one or more of the other explicit illustrative embodiments and modifications. As such, many other embodiments, modifications, and equivalents thereto, either exist now or are yet to be discovered and, thus, it is neither intended nor possible to presently describe all such subject matter, which will readily be suggested to persons of ordinary skill in the art in view of the present disclosure. Rather, the present disclosure is intended to embrace all such embodiments and modifications of the subject matter of this application, and equivalents thereto, as fall within the broad scope of the accompanying claims.

1. An axle configuration, comprising:
a geartrain having an input, a first output coupled to a first axle shaft, and a second output; and
a clutch having an input coupled to the second output of the geartrain, and an output, wherein the clutch includes a passive overrunning clutch.

2. The axle configuration of claim 1, wherein the clutch is a single plane dynamically controllable clutch and passive one way clutch.

3. The axle configuration of claim 2, wherein the clutch is passive for vehicle forward operation.

4. The axle configuration of claim 1, wherein the clutch has an axial length to major outer diameter ratio of less than 0.5.

5. The axle configuration of claim 1, wherein the axle configuration is for a front axle and the first axle shaft is a first front half shaft.

6. The axle configuration of claim 1, wherein the axle configuration is for a rear axle and the first axle shaft is a first rear half shaft.

7. The axle configuration of claim 1, further comprises a disconnect device enabling passive engagement and disengagement of a half shaft to provide control to engage and disengage a secondary axle of dual axles.

8. The axle configuration of claim 7, wherein the half shaft includes a first half shaft portion coupled at an input side of the clutch, and a second half shaft portion coupled at an output side of the clutch.

9. The axle configuration of claim 7, wherein the clutch includes a coupling portion and a control portion coupled to the coupling portion.

10. The axle configuration of claim 9, wherein the coupling portion includes a first coupling member, a second coupling member, and a plurality of locking members.

11. The axle configuration of claim 9, wherein the control portion includes a stator assembly, a translator, and an actuator assembly.

12. The axle configuration of claim 9, wherein the control portion constitutes a bi-stable actuator.

13. A clutch assembly, comprising:
a first coupling including a locking face including a plurality of locking formations;
a second coupling including a front face facing the locking face of the first coupling and including a plurality of passive strut pockets, a plurality of active strut pockets circumferentially interspersed amongst the plurality of passive strut pockets, and a plurality of actuator passages open to the plurality of active strut pockets;
a plurality of passive struts carried in the passive strut pockets of the second coupling; and
a plurality of active struts, different from the passive struts, and carried in the active strut pockets of the second coupling.

14. The clutch assembly of claim 13, wherein the first coupling includes a base wall having the plurality of locking formations and an axial wall extending axially away from the base wall, and wherein the second coupling is carried axially within an axial extent of the axial wall and is retained thereto by a retainer ring with the pluralities of passive and active struts positioned between the second coupling and the base wall of the first coupling.

15. The clutch assembly of claim 14, wherein the first coupling is a bowl-shaped component.

16. The clutch assembly of claim 14, wherein the second coupling is a plate-shaped component.

17. The clutch assembly of claim 13, wherein the passive struts are passive one way clutch struts, whereas the active struts are dynamically controllable clutch struts.

18. A method of operating a motor vehicle drivetrain, comprising:
driving a geartrain in a vehicle forward two-wheel drive mode, wherein a clutch assembly coupled between the geartrain and a vehicle wheel is in an overrunning passive one way clutch state with a dynamically controllable clutch deactivated;
driving the geartrain in a vehicle forward four-wheel drive mode, wherein the clutch assembly is in an engaged passive one way clutch state with the dynamically controllable clutch deactivated;
driving the geartrain in a vehicle reverse four-wheel drive mode, wherein the clutch assembly is in an engaged passive one way clutch state with the dynamically controllable clutch activated; and
driving the geartrain in a regenerative vehicle forward four-wheel drive mode, wherein the clutch assembly is in an engaged passive one way clutch state with the dynamically controllable clutch activated.

19. The method of operating a motor vehicle drivetrain of claim 18, further comprising driving the geartrain in a reverse two-wheel drive mode, wherein the clutch assembly is in an engaged passive one way clutch state with the dynamically controllable clutch deactivated.

20. The method of operating a motor vehicle drivetrain of claim 18, wherein the engaged passive one way clutch state provides half shaft engagement in a vehicle forward direction.
